(19) United States
(12) Patent Application Publication
(10) Pub. No.: US 2007/0062758 A1
(43) Pub. Date: Mar. 22, 2007

(54) Laminated steel having non-continuous viscoelastic layer

(76) Inventors: Charles E. Jensen, Macomb, MI (US); Charles J. Bruggemann, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/230,379

(22) Filed: Sep. 20, 2005

(51) Int. Cl. E04B 1/82; E04B 2/02; F01N 1/00; G01K 1/00

(52) U.S. Cl. 181/290; 181/296

(57) ABSTRACT

A laminated steel having a non-continuous viscoelastic layer. The viscoelastic material is absent (voided) at certain predetermined locations of the laminated steel, particularly predetermined potential weld locations. Preferably, the outside surface of at least one of the metal sheets is marked to indicate each location of absence of the viscoelastic material. Advantageously, welding of the laminated steel at the absences of viscoelastic material will be more easily performed than if the viscoelastic material had been present at the weld site.

### TECHNICAL FIELD

The present invention relates to laminated steel having a continuous viscoelastic layer sandwiched between two sheets of metal. More particularly, the present invention relates to a laminated steel in which the viscoelastic layer is non-continuous, particularly at predetermined potential welding locations.

### BACKGROUND OF THE INVENTION

Laminated steel has two sheets of metal (usually, but not necessarily, steel) which are adhesively joined together by a viscoelastic layer therebetween. An advantage of the viscoelastic layer is its vibration attenuating properties, wherein vibration (noise or sound) acquired and/or conducted by either or both of the metal sheets is damped by the viscoelastic layer. Laminated steel is desirable in the automotive industry for utilization in body components since the vibration damping provided by the viscoelastic layer results in quieter motor vehicles.

The viscoelastic layer must have two essential qualities: (1) it must provide vibration damping by conversion of vibration into thermal energy with particularly excellent performance around a predetermined operational range of temperature; and (2) it must provide a strong and lasting adhesion to each of the metal sheets. Viscoelastic materials for such purposes are well known in the art, as represented by U.S. Pat. Nos. 3,931,448; 4,942,219; 5,061,778; 5,183,863; and 5,288,813; and include, for example, compositions made of a polyester or polyesters, polyester incorporating a plasticizer, polyester incorporating an organic peroxide, polyurethane foam, polyamide, ethylene-vinyl acetate copolymer, polyvinyl butyral or polyvinyl butyral-polyvinyl acetate incorporating a plasticizer and a tackifier, coplymer of isocyanate prepolymer and vinyl monomer, or another copolymer.

In a typical manufacturing process, as described in Example 1 of U.S. Pat. No. 5,288,813, each of the metal sheets is coated (to a depth of 25 micrometers) with a viscoelastic material, then the coated surfaces are joined together under pressure (20 kg/cm²) at an elevated temperature (220 degrees C.) for a selected time (30 seconds).

While laminated steel performs very well in terms of structural integrity and vibration damping, it suffers from difficulty to weld because of the viscoelastic material at the weld site.

Accordingly, what is needed in the art is a laminated steel wherein the viscoelastic layer is non-continuous such that at predetermined locations the viscoelastic material is absent, particularly absent at predetermined potential weld locations.

### SUMMARY OF THE INVENTION

The present invention is a laminated steel wherein the viscoelastic layer thereof is non-continuous. By the term “non-continuous” is meant the viscoelastic material is absent (voided) at certain predetermined locations of the laminated steel, and wherein the predetermined locations are preferably known potential weld areas of the laminated steel. It is to be understood that although the term “laminated steel” is used herein, it is to be interpreted to mean any kind of metal sheets (steel, stainless steel, aluminum, etc.) joined together by a viscoelastic layer.

According to the method of the present invention, a viscoelastic material is applied, as for example by spraying or printing, onto a surface of at least one of the metal sheets. The viscoelastic material is applied by the applicator using, for example, a computer program or a mask, whereby the viscoelastic material is applied non-continuously to the inside surface of at least one of the metal sheets, wherein local regions of the inside surface are free of the viscoelastic material (i.e., the inside surface has absences of viscoelastic material). Thereafter, the interior surfaces of the metal sheets are arranged so as to mutually face each other, then are compressibly joined to thereupon form the laminated steel.

In the preferred embodiment of the laminated steel according to the present invention, the outside of at least one of the metal sheets is marked, as for example durable markings provided by printing, so as to indicate each location of absence of the viscoelastic layer.

Accordingly, it is an object of the present invention to provide a laminated steel having a non-continuous viscoelastic layer, wherein predetermined locations of the viscoelastic layer are absent, particularly locations whereat welds may be effected.

This and additional objects, features and advantages of the present invention will become clearer from the following specification of a preferred embodiment.

### BRIEF DESCRIPTION OF THE DRAWINGS

FIG. 1 is a perspective view of a laminated steel with a non-continuous viscoelastic layer according to the present invention.

FIG. 2 is a cross-sectional view, seen along line 2-2 of FIG. 1.

FIG. 3 is a partly exploded view of the laminated steel shown at FIG. 1.

FIG. 4 is a sectional view of the laminated steel as in FIG. 2, now shown in operation welded to a structural component.

FIG. 5 is a schematic view of an apparatus to provide a laminated steel having a non-continuous viscoelastic layer according to the present invention.

### DESCRIPTION OF THE PREFERRED EMBODIMENT

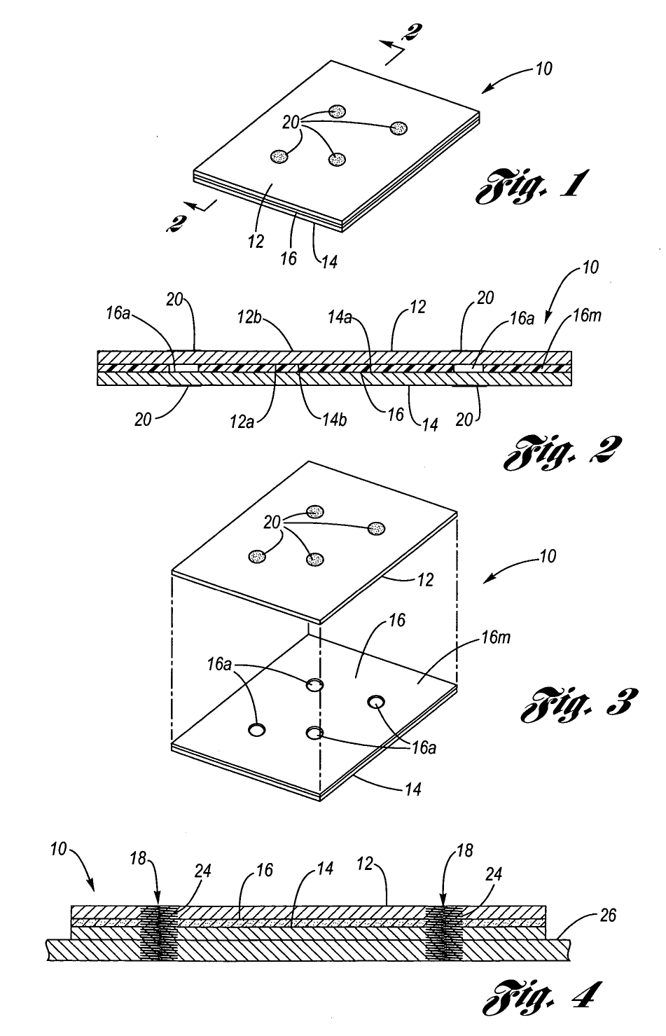

Referring now to the Drawing, FIGS. 1 through 3 depict an example of a laminated steel 10 according to the present invention. The laminated steel 10 includes a first metal sheet 12 having inside and outside surfaces 12a, 12b, a second metal sheet 14 having inside and outside surfaces 14a, 14b (the metal sheets being composed of any metal, most preferably steel) and a non-continuous viscoelastic layer 16 therebetween, wherein the viscoelastic layer adhesively joins the inside surface of each of the first and second metal sheets thereto. The viscoelastic layer 16 is non-continuous in the sense that the viscoelastic material 16m thereof is absent 16a at certain predetermined locations of the laminated steel 10. Most preferably, the predetermined locations have a one-to-one positional correspondence with known potential weld areas 18 of the laminated steel 10 (discussed hereinbelow with respect to FIG. 4).

The viscoelastic material 16m of the viscoelastic layer 16 is of a type known in the art, as for a non-limiting example: compositions made of a polyester or polyesters, polyester incorporating a plasticizer, polyester incorporating an organic peroxide, polyurethane foam, polyamide, ethylene-vinyl acetate copolymer, polyvinyl butyral or polyvinyl butyral-polyvinyl acetate incorporating a plasticizer and a tackifier, coplymer of isocyanate prepolymer and vinyl monomer, another copolymer, or any other material known in the art for use in a laminated steel, as for example disclosed in U.S. Pat. No. 5,288,813, issued Feb. 22, 1994, the disclosure of which is hereby incorporated herein by reference.

It is most preferred for one, or both, of the outside surfaces 12b, 14b of the first and second metal sheets 12, 14 to have markings 20 so as to delineate the location of each of the absences 16a of the viscoelastic material 16m. In this regard, it is preferred for each of the markings 20 to delineate the position, size and shape of its respective absence 16a of viscoelastic material 16m by superposing the absence. The markings 20 can take any suitable form, as for example a solid marking or an outline marking, and may be provided by any suitable modality, such as for example printing of an ink onto one or both of the outside surfaces 12b, 14b.

In operation of the laminated steel 10 according to the present invention as shown at FIG. 4, welds 24 are made of the laminated steel 10 to a secondary structural member 26, wherein each of the welds has a weld location 18 which corresponds positionally to an absence 16a of the viscoelastic material 16m. Accordingly, the welds 24 are performed easily because the weld sites are free of the viscoelsatic material.

Turning attention now to FIG. 5, an example of a method for making the laminated steel 10 according to the present invention will be discussed, wherein a laminating apparatus 30 is utilized.

The laminating apparatus 30 includes a frame 32. Disposed on the frame 32 is a roller set 34 including first and second rollers 34a, 34b which are pressed towards each other via a press 36. A first metal sheet 12′ is delivered from a first metal sheet roll 12r under guidance of a guide roller 40. A second metal sheet 14′ is delivered from a second metal sheet roll 14r. The viscoelastic material 16m′ is selectively applied to the inside surface 14a′ of the second metal sheet 14′ via an applicator 42 connected with a bulk source 44 of the viscoelastic material. The applicator 42, which may be any suitable applicator, as for example a printing or spray head, is preferably controlled by an electronic controller 46 so that the absences of viscoelastic material (see 16a in FIGS. 1 through 3) are automatically provided; however, alternatively, a mask 48 may be employed to mechanically provide the absences of the viscoelastic material. A conventional heating apparatus 38 serves to melt or soften the non-continuous viscoelastic material 16m′ carried on the second metal sheet 14′.

Also attached to the frame 32 is a conventional block laminator 50, which includes an upper plate assembly 52 physically and thermally coupled to an upper heat exchanger 54 and a lower plate assembly 56 physically and thermally coupled to a lower heat exchanger 58, wherein the upper and lower heat exchangers are used for cooling. The upper heat exchanger 54 is connected to a plurality of actuators 60 for applying selective pressure to the forming laminated steel 14′ as is slides between the upper and lower plate assemblies 52, 56. Details of a suitable block laminator are disclosed in U.S. Pat. No. 5,851,342, the disclosure of which is hereby incorporated herein by reference.

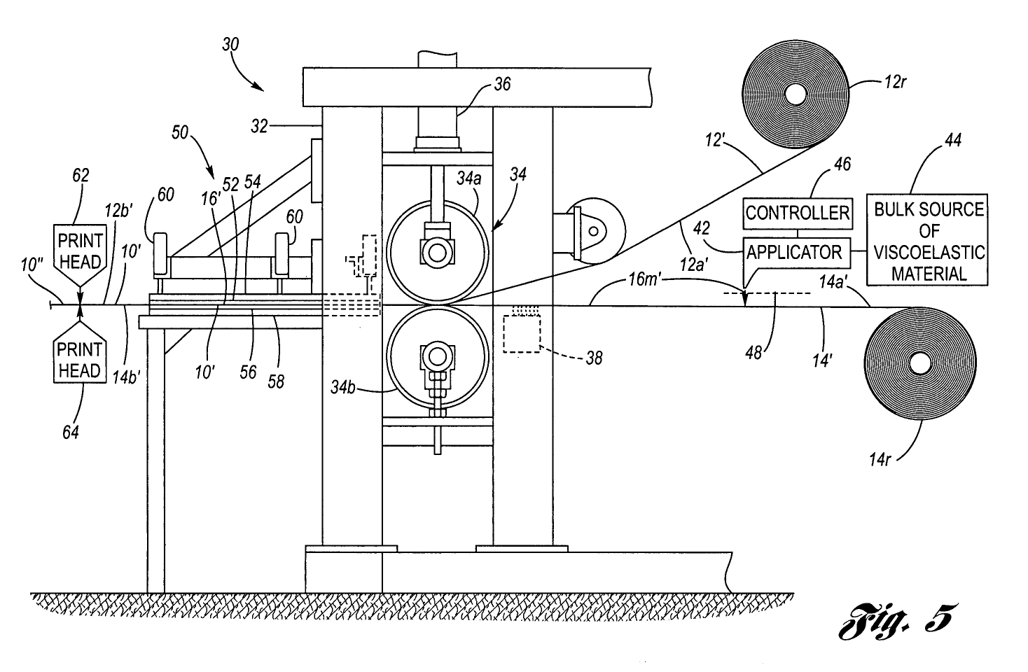

A pair of print heads 62, 64 are provided on either side of the forming laminated steel 10′, whereby one print head 62 prints on the outside surface 12b′ of the first metal sheet 12′ and the other print head 64 prints on the exterior surface 14b′ of the second metal sheet. The print heads 62, 64 print markings (see 20 in FIGS. 1 through 3) indicative of the locations of the absences of viscoelastic material (see 16a in FIGS. 2 and 3), as discussed hereinabove. Preferably the printing by the print heads 62, 64 is controlled by the aforesaid electronic controller 46, otherwise a mask (not shown) may be utilized to control the printing of the markings.

In operation, the metal sheets 12′, 14′ are drawn into the laminating apparatus 30 in unison, and the applicator 42 selectively applies the viscoelastic material 16m′ onto the inside surface 14a′ of the second sheet 14′(it is to be understood that this is merely an exemplification, as the applicator could apply the viscoelastic material to the inside surface 12a′ alternatively or additionally). The viscoelastic material is applied in a non-continuous manner so that absences (or voids) of the viscoelastic material (see 16a in FIGS. 2 and 3) are provided. The absences of viscoelastic material are initially sized to take into account melting and/or squeezing in the laminator apparatus 30 so that the final sizes of the absences are appropriate to provide viscoelastic absent welds at the predetermined weld areas, as discussed hereinabove.

The heater 38 melts or softens the viscoelastic material, then the inside surfaces of the first and second metal sheets are squeezed together by the roller set 34, thereby ensuring good adhesion of the viscoelastic material to the metal sheets. Additionally at this stage of operation, the viscoelastic material has a proper thickness and the non-continuous distribution of the viscoelastic material has properly sized absences.

Next, the forming laminated steel 10′ is delivered to the block laminator 50 while the viscoelastic layer 16′ is still hot, wherein the metal sheets are respectively in contact with the upper and lower plate assemblies. The block laminator applies selective pressure to the forming laminated steel 10′ and at the same time cools the hot viscoelastic material 16′, whereupon the viscoelastic material permanently bonds to the first and second metal sheets.

Next, the print heads 62, 64 print markings (see 20 in FIGS. 1 through 3) onto the outside surfaces 12b′, 14b′ of the first and second metal sheets to delineate the locations of the absences of the viscoelastic material.

Lastly, the fully formed laminated steel 10″ is either rolled or cut into size and shaped (if necessary) as needed to provide a laminated steel 10 (see FIG. 1) for production. During production, welding (as shown at FIG. 4) is easily performed at any of the absences of viscoelastic material.

To those skilled in the art to which this invention appertains, the above described preferred embodiment may be subject to change or modification. Such change or modification can be carried out without departing from the scope of the invention, which is intended to be limited only by the scope of the appended claims.

1. A laminated steel, comprising:
a first metal sheet having an inside surface and an opposite outside surface;
a second metal sheet having an inside surface and an opposite outside surface; and
a viscoelastic layer of viscoelastic material disposed between said first and second metal sheets, wherein said viscloelastic material adheres to the inside surfaces of said first and second metal sheets;
wherein said viscoelastic layer is non-continuous such that the viscoelastic layer has at least one absence of the viscoelastic material.

2. The laminated steel of claim 1, wherein said at least one absence of the viscoelastic material has a one-to-one correspondence to at least one predetermined potential weld location of said laminated steel.

3. The laminated steel of claim 2, further comprising at least one marking on the outside surface of at least one of said first and second metal sheets, wherein said at least one marking demarcates the location of said at least one absence of said viscoelastic material.

4. The laminated steel of claim 3, wherein said at least one marking is superposed said at least one absence of said viscoelastic material.

5. A laminated steel, comprising:
a first metal sheet having an inside surface and an opposite outside surface;
a second metal sheet having an inside surface and an opposite outside surface; and
a viscoelastic layer of viscoelastic material disposed between said first and second metal sheets, wherein said viscloelastic material adheres to the inside surfaces of said first and second metal sheets;
wherein said viscoelastic layer is non-continuous such that the viscoelastic layer has a plurality of absences of the viscoelastic material, and wherein each said absence of the viscoelastic material has a one-to-one correspondence to a respective predetermined potential weld location of said laminated steel.

6. The laminated steel of claim 5, further comprising a plurality of markings on the outside surface of at least one of said first and second metal sheets, wherein each marking of said plurality of markings demarcates the location of a respective said absence of said viscoelastic material.

7. The laminated steel of claim 6, wherein each said marking is superposed its respective said absence of said viscoelastic material.

8. A method for providing a product, comprising the steps of:
determining at least one potential weld location of a laminated steel;
providing a first metal sheet having an inside surface and an opposite outside surface;
providing a second metal sheet having an inside surface and an opposite outside surface;
placing a viscoelastic layer composed of a viscoelastic material to the inside surface of at least one of said first and second metal sheets, wherein at least one absence of said viscoelastic material is provided, said at least one absence of said viscoelastic material having a one-to-one positional correspondence to said at least one potential weld location; and
adhering said inside surfaces of said first and second metal sheets to said viscoelastic layer to thereby provide the laminated steel.

9. The method of claim 8, further comprising placing at least one marking on the outside surface of at least one of said first and second metal sheets, wherein said at least one marking demarcates the position of said at least one absence of viscoelastic material within the laminated steel.

10. The method of claim 9, further comprising:
providing a structural component; and
welding the laminated steel to the structural component, wherein the welding is performed only at the at least one absence of the viscoelastic material.
